(19) United States
(12) Patent Application Publication
(10) Pub. No.: US 2016/0307688 A1
(43) Pub. Date: Oct. 20, 2016

(54) CHIP COMPONENT AND METHOD OF MANUFACTURING THE SAME

(71) Applicant: SAMSUNG ELECTRO-MECHANICS CO., LTD., Suwon-si (KR)

(72) Inventor: Jong Ik PARK, Suwon-si (KR)

(21) Appl. No.: 15/077,608

(22) Filed: Mar. 22, 2016

(30) Foreign Application Priority Data
Apr. 16, 2015 (KR) 10-2015-0054040

(51) Int. Cl. H01F 27/28; H01F 27/02; H01F 41/02

(52) U.S. Cl. CPC H01F 27/28; H01F 41/02; H01F 27/022

(57) ABSTRACT

A chip component includes a first body part in which at least one pillar part is formed, a winding coil having a central portion fitted onto the at least one pillar part, and a second body part stacked on the first body part so that the winding coil is embedded between the first body part and the second body part.

### CROSS-REFERENCE TO RELATED APPLICATION

This application claims benefit of priority to Korean Patent Application No. 10-2015-0054040, filed on Apr. 16, 2015 with the Korean Intellectual Property Office, the disclosure of which is incorporated herein by reference.

### TECHNICAL FIELD

The present disclosure relates to a chip component and a method of manufacturing the same.

### BACKGROUND

An inductor, one kind of chip electronic component, is a representative passive element configuring an electronic circuit together with a resistor and a capacitor to remove noise. The inductor is combined with the capacitor using an electromagnetic property to configure a resonance circuit amplifying a signal in a specific frequency band, a filter circuit, or the like.

Recently, as miniaturization and thinness of information technology (IT) devices such as various communications devices, display devices, or the like, have been accelerated, research into a technology for miniaturizing and thinning various elements such as an inductor, a capacitor, a transistor, and the like, used in these IT devices has been continuously conducted. Therefore, the inductor has also been rapidly changed into a chip that has a compact size, has high density, and may be automatically surface-mounted.

### SUMMARY

An aspect of the present disclosure may provide a chip component in which a pillar part onto which a winding coil may be fixed is formed in a body part to stably mount the winding coil, and a method of manufacturing the same.

According to an aspect of the present disclosure, a chip component may include a first body part in which at least one pillar part is formed, a winding coil having a central portion fitted onto the at least one pillar part, and a second body part stacked on the first body part so that the winding coil is embedded between the first body part and the second body part.

Inside the chip component, space surrounding the at least one pillar part but not occupied by the winding coil may be completely filled with the second body part.

The pillar part may be formed on an upper surface of the first body part, and the second body part may be stacked on the upper surface of the first body part.

The first body part may have a step between the pillar part onto which the central portion of the winding coil is fitted and a groove part in which the winding coil is seated are formed in the first body part.

The first body part may have strength greater than that of the second body part.

A size of a top portion of the at least one pillar part may be less than that of a bottom portion of the one pillar part, the top portion of the at least one pillar part being closer to the second body part than the bottom portion of the at least one pillar part.

An inner size of the winding coil may be greater than that of the top portion of the at least pillar part and less than that of the bottom portion of the at least pillar part.

The size of the bottom portion of the at least one pillar part may gradually increase in a direction away from the second body part.

The top portion of the at least one pillar part may linearly extend towards the bottom portion thereof.

The chip component may further include a plurality of peripheral pillar parts surrounding the at least one pillar part.

A first groove part between two adjacent pillar parts of the plurality of peripheral pillar parts on a first side surface of the first body part, a second groove part between two adjacent pillar parts of the plurality of peripheral pillar parts on a second side surface of the first body part opposing the first side surface thereof, and a third groove part between the at least one pillar part and one of the plurality of peripheral pillar parts on a third side surface of the first body part connecting the first and second side surfaces, may be aligned to each other in a direction parallel the third side surface.

The winding coil may not directly contact any of the plurality of peripheral pillar parts.

According to another aspect of the present disclosure, a method of manufacturing a chip component may include: forming at least one pillar part by processing a first body part; fitting and seating a central portion of a winding coil onto the at least one pillar part; embedding the winding coil between the first body part and a second body part by adding the second body part; and compressing and hardening a body part including the first body part and the second body part.

The method may further include forming individual chips by cutting the body part.

The embedding of the winding coil may include embedding the winding coil between the first body part and the second body part by stacking the second body part on an upper surface of the first body part.

In the embedding of the winding coil, the second body part may be molded in a sheet type and compressed to the first body part such that the second body part completely fills space surrounding the at least one pillar part but not occupied by the winding coil.

The forming of the at least one pillar part may include dicing the first body part to form the pillar part onto which the central portion of the winding coil is fitted and a groove part in which the winding coil is seated.

The forming of the at least one pillar part may further include molding the first body part in a sheet type and hardening the first body part to a predetermined strength so as to be diced.

The dicing the first body part to form the at least one pillar part may partially cut the first body part in a thickness direction thereof.

The first body part may have strength greater than that of the second body part.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view illustrating a schematic structure of a chip component according to an exemplary embodiment in the present disclosure;

FIG. 2 is a view illustrating the schematic exploded structure of the chip component according to an exemplary embodiment in the present disclosure;

FIGS. 3 through 6 are cross-sectional views schematically illustrating a method of manufacturing a chip component according to an exemplary embodiment in the present disclosure;

FIG. 7 is a schematic side view of the chip component according to an exemplary embodiment in the present disclosure; and

FIG. 8 is a view illustrating the method of manufacturing a chip component according to an exemplary embodiment in the present disclosure.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

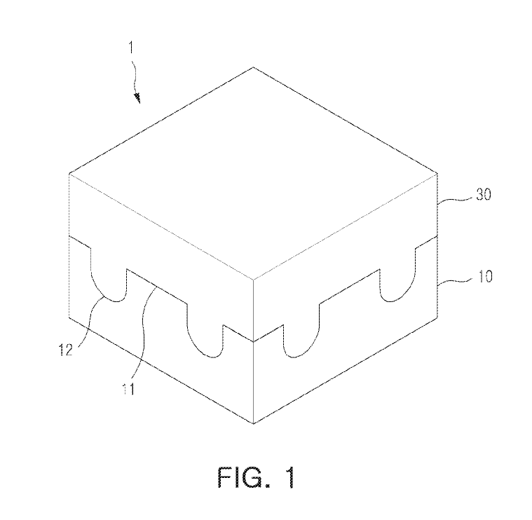

FIG. 1 is a perspective view illustrating a schematic structure of a chip component according to an exemplary embodiment in the present disclosure.

Referring to FIG. 1, the chip component 1 may include a first body part 10, a winding coil (not illustrated), and a second body part 30.

The first body part 10 and the second body part 30, which are provided in the chip component 1 and form an exterior of the chip component, may be provided in a surrounding space of the winding coil. The first body part 10 and the second body part 30 may contain one or more of, for example, a magnetic metal powder, ferrite, a resin mixture, and the like. Here, a step between a pillar part 11 and a groove part 12 may be formed on an interface between the first body part 10 and the second body part 30.

The winding coil (not illustrated) may be disposed in a body including the first body part 10 and the second body part 30, and may be electrically connected to external electrodes. For example, both end portions of the winding coil may be connected, respectively, to external electrodes formed on outer surfaces of the chip component 1. Here, shapes and positions of the external electrodes may be variously determined as needed in a design and a process.

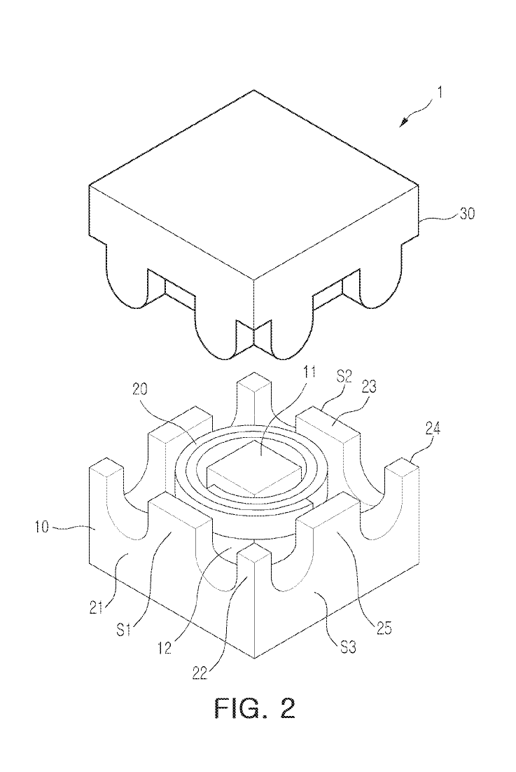

FIG. 2 is a view illustrating the schematic exploded structure of the chip component according to an exemplary embodiment in the present disclosure.

Referring to FIG. 2, the chip component 1 according to the exemplary embodiment may include the first body part 10, a winding coil 20, and the second body part 30. An example of the chip component may include an inductor. The inductor may be used as a representative passive element configuring an electronic circuit together with a resistor and a capacitor to remove noise.

The first body part 10, which is provided in the chip component 1 and forms the exterior of the chip component, together with the second body part 30, may be provided in the surrounding space of the winding coil 20. The first body part 10 may contain one or more of, for example, a magnetic metal powder, ferrite, a resin mixture, and the like. For example, the first body part 10 may be formed of a magnetic material-resin composite in which magnetic metal powder and a resin mixture are mixed with each other. Alternatively, the first body part 10 may be formed of a magnetic material-resin composite in which ferrite and a resin mixture are mixed with each other. Alternatively, the first body part 10 may be formed of only a resin mixture. However, a material and a form of the first body part 10 are not limited thereto.

In particular, the first body part 10 may be provided in a sheet type and compressed and hardened to the second body part 30, and thus the first body part 10 and the second body part 30 may be stacked. For example, in the first body part 10, the magnetic metal powder, the resin mixture, and the like, may be molded in the sheet type, and may be stacked, compressed, and then hardened on at least one surface of the winding coil 20. The first body part 10 may contain materials for obtaining a high magnetic property and DC-bias of a coil inductor as an example, particularly, the magnetic metal powder and the resin mixture. Here, coarse powder and fine powder having Fe, Cr, and Si as main components thereof may be used as the magnetic metal powder, and an epoxy based resin may be used as the resin mixture. A sheet having a predetermined thickness may be formed through this process.

At least a portion of the first body part 10 may be processed, and thus at least one pillar part 11 may be formed.

This processing may be performed by physical, optical, and chemical units, and a size and a shape of the pillar part 11 may be variously determined as needed in a design and a manufacturing process.

The first body part 10 may be diced, and thus a step is formed in the first body part 10, and may include the groove part 12, which is a diced part, and the pillar part 11, which is the remaining part. That is, the pillar part 11 onto which a central portion of the winding coil 20 is fitted may fix the winding coil 20 thereonto, and the groove part 12 may seat the winding coil 20 therein. The first body part 10 may be in a hardened state at a predetermined strength or more so as to be diced as described above.

In order to dice the first body part, for example, a dicing blade may be used. The groove part 12 of which the bottom is curved may be formed by the dicing blade. Here, a shape of the groove part 12 may be changed depending on a form of the used dicing blade. For example, pillar parts having various sizes may be processed depending on a dicing blade kerf and a dicing pitch value.

As described above, the step between the pillar part 11 and the groove part 12 formed in the first body part 10 by dicing the first body part 10 may have a predetermined thickness or more to secure a sufficient space, whereby the winding coil may be stably seated in the first body part 10. Here, a depth t2 of the groove part 12 formed by dicing the first body part 10 may be set to 50% or less of an entire thickness t1 of the first body part 10, as illustrated in FIG. 4. However, the depth t2 of the groove part 12 may be modified depending on a material, a degree of hardening, and the like, of the first body part 10. With reference to FIG. 4 to be described later, a shape of the pillar part 11 will be explained in detail.

The winding coil 20, which is a coil wound at least once or more, may be an air-core coil in which the pillar part 11 may be accommodated. The winding coil 20 may be disposed in the body including the first body part 10 and the second body part 30, and the central portion of the winding coil 20 may be fitted and fixed onto the at least one pillar part 11 formed in the first body part 10.

In a case in which the step is formed in the first body part 10 by dicing the first body part 10, such that the pillar part 11 and the groove part 12 are formed in the first body part 10, the central portion of the winding coil 20, which is an air-core part of the winding coil 20, may be fitted onto the pillar part 11, and a winding part of the winding coil 20 may be seated in the groove part 12, whereby the winding coil 20 may be stably disposed in the body part.

Meanwhile, the winding coil 20 may be electrically connected to the external electrodes formed on the outer surfaces of the chip component 1. For example, both end portions of the winding coil 20 may be electrically connected to the external electrodes, respectively.

The second body part 30, which is provided in the chip component 1 and forms the exterior of the chip component, together with the first body part 10, may be provided in the surrounding space of the winding coil 20. The second body part 30 may contain one or more of, for example, a magnetic metal powder, ferrite, a resin mixture, and the like, similar to the first body part 10. For example, the second body part 30 may be formed of a magnetic material-resin composite in which magnetic metal powder and a resin mixture are mixed with each other. Alternatively, the second body part 30 may be formed of a magnetic material-resin composite in which ferrite and a resin mixture are mixed with each other. Alternatively, the second body part 30 may be formed of only a resin mixture. However, a material and a form of the second body part 30 are not limited thereto.

In particular, the second body part 30 may be provided in a sheet type and compressed and hardened to the first body part 10. For example, in the second body part 30, the magnetic metal powder, the resin mixture, and the like, may be molded in the sheet type, and may be stacked, compressed, and then hardened on at least one surface of the winding coil 20. The second body part 30 may be formed of the same material as that of the first body part 10 or formed of a material different from that of the first body part 10.

The second body part 30 may be formed together with the first body part 10 in a stacked structure so that the winding coil 20 is embedded therein. In a case in which the pillar part 11 is formed by processing an upper surface of the first body part 10, the second body part 30 may be formed on the upper surface of the first body part 10. That is, the first body part 10 may be disposed below the second body part 30, the second body part 30 may be disposed above the first body part 10, and the winding coil 20 may be embedded in a space between the first body part 10 and the second body part 30.

In addition, in a case in which the pillar part 11 is formed by processing a lower surface of the first body part 10, the second body part 30 may be formed on the lower surface of the first body part 10, and thus the winding coil 20 may be embedded between the first body part 10 and the second body part 30. That is, the first body part 10 may be disposed above the second body part 30, the second body part 30 may be disposed below the first body part 10, and the winding coil 20 may be embedded in a space between the first body part 10 and the second body part 30.

Meanwhile, the step between the pillar part 11 and the groove part 12 may be formed on the interface between the first body part 10 and the second body part 30. Since the first body part 10 is diced, such that the step is formed in the first body part 10, the first body part 10 may be hardened at strength greater than that of the second body part 30, and the second body part 30 may be hardened at strength less than that of the first body part 10 so as to cover the upper surface or the lower surface of the first body part 10.

As shown in FIG. 2, a plurality of peripheral pillar parts may surround the pillar part 11 formed at the center of the first body part 10. The plurality of peripheral pillar parts may include peripheral pillar parts 21 and 22 located at a first surface S1 of the first body part 10, peripheral pillar parts 23 and 24 located at a second surface S2 of the first body part 10 opposing the first surface, and a peripheral pillar part 25 located on a third surface S3 connecting the first and second surfaces S1 and S2 of the first body part 10. A groove part 12 between the peripheral pillar parts 21 and 22, a groove part 12 between the peripheral pillar parts 23 and 24, and a groove part between the pillar part 11 which the winding coil 20 is fitted in and the peripheral pillar part 25, may be aligned to each other along a direction parallel to the third surface S3, since all these groove parts 12 are formed by the same linear cut during the dicing process. The other grooves parts 12 formed by the respective same linear cut may be aligned to each other. To avoid redundancy, a description thereof will be omitted.

As described above, in the chip component according to an exemplary embodiment, the pillar part may be formed in the body to fix the winding coil thereonto. Therefore, a technology of fixing the winding coil may be improved, and thus productivity may be improved and manufacturing costs may be reduced.

Hereinafter, a method of manufacturing a chip component according to an exemplary embodiment will be described in detail by way of example.

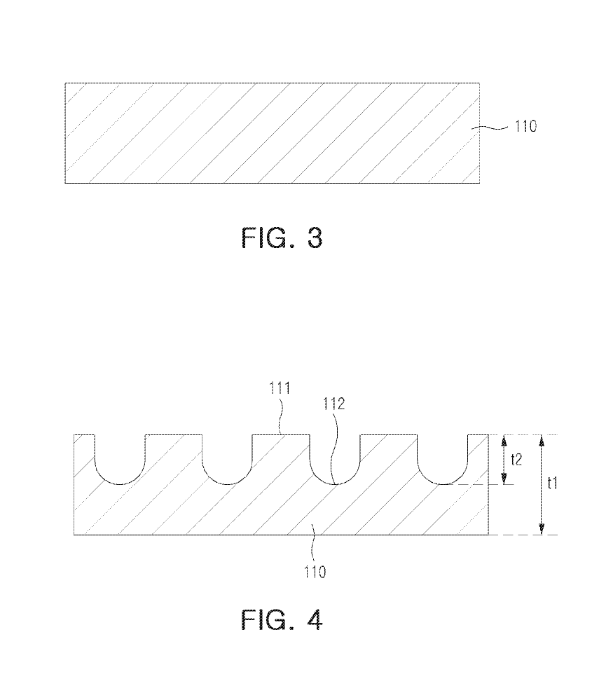

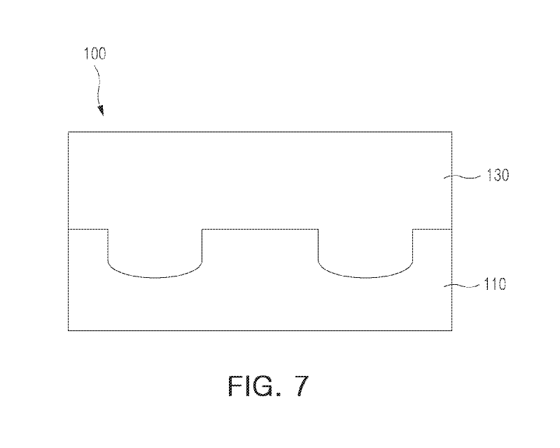

FIGS. 3 through 6 are cross-sectional views sequentially illustrating operations of a method of manufacturing a chip component according to an exemplary embodiment in the present disclosure. In addition, FIG. 7 is a schematic side view of a completed chip component according to an exemplary embodiment.

Referring to FIGS. 3 through 7, the method of manufacturing a chip component according to an exemplary embodiment in the present disclosure may include forming the at least one pillar part by processing the first body part, fitting and seating the central portion of the winding coil onto the pillar part, embedding the winding coil between the first body part and the second body part by adding the second body part to cover the winding coil, and compressing and hardening the body including the first body part and the second body part.

In addition, the method of manufacturing a chip component may further include forming individual chips by cutting the body part.

According to the exemplary embodiment as described above, the body part may be processed to fix the winding coil, whereby the winding coil may be stably mounted. In addition, a method of fixing the winding coil may be improved through a change from a mold type process according to the related art into a sheet type process, and thus a manufacturing process may be further simplified and a yield of a product may also be improved.

Hereinafter, respective processes of the present exemplary embodiment will be described in more detail with reference to FIGS. 3 through 7.

First, as illustrated in FIGS. 3 and 4, in the method of manufacturing a chip component according to an exemplary embodiment, the at least one pillar part 111 may be formed by processing at least a portion of the first body part 110.

Referring to FIG. 3, the first body part 110, which is provided in the chip component and forms the exterior of the chip component, may be provided in the surrounding space of the winding coil 120. The first body part 110 may contain one or more of a magnetic metal powder, ferrite, a resin mixture, and the like. For example, the first body part 110 may be formed of a magnetic material-resin composite in which magnetic metal powder and a resin mixture are mixed with each other. Alternatively, the first body part 110 may be formed of a magnetic material-resin composite in which ferrite and a resin mixture are mixed with each other. Alternatively, the first body part 110 may be formed of only a resin mixture, but is not limited thereto.

In particular, in a process of forming the pillar part 111, the first body part 110 may be molded in the sheet type, and may be hardened to a predetermined strength so as to be diced. For example, in the first body part 110, the magnetic metal powder and the resin mixture may be molded in the sheet type and hardened. Therefore, the first body part 110 may be diced later, and thus the pillar part 111 may be formed in the first body part 110. The first body part 110 may contain materials for obtaining high magnetic properties and DC-bias of a coil inductor as an example, particularly, the magnetic metal powder and the resin mixture. Here, coarse powder and fine powder having Fe, Cr, and Si as main components thereof may be used as the magnetic metal powder, and an epoxy based resin may be used as the resin mixture. A sheet having a predetermined thickness may be formed through this process.

Referring to FIG. 4, the at least one pillar part 111 may be formed by processing at least a portion of the first body part 110. This processing may be performed by physical, optical, and chemical units, and a size and a shape of the pillar part 111 may be variously determined as needed in a design and a manufacturing process.

In the process of forming the pillar part 111, the pillar part 111 onto which the central portion of the winding coil 120 is fitted and the groove part 112 in which the winding coil 120 is seated may be formed in the first body part 110 by dicing the first body part 110. That is, the pillar part 111 onto which a central portion of the winding coil 120 is fitted may fix the winding coil 120 thereonto, and the groove part 112 may seat the winding coil 120 therein. Here, the first body part 110 may be in a hardened state at a predetermined strength or more so as to be diced as described above.

In order to dice the first body part 110, for example, a dicing blade may be used. The groove part 112 of which the bottom is curved may be formed by the dicing blade. Here, a shape of the groove part 112 may be changed depending on a form of the used dicing blade. That is, pillar parts having various sizes may be processed depending on a dicing blade kerf. In addition, pillar parts having various sizes may be processed depending on a dicing pitch value.

As described above, the step between the pillar part 111 and the groove part 112 formed in the first body part 110 by dicing the first body part 110 may have a predetermined thickness or more to secure a sufficient space, whereby the winding coil may be stably seated. Here, a depth t2 of the groove part 112 formed by dicing the first body part 110 may be set to 50% or less of an entire thickness t1 of the first body part 110. However, the depth t2 of the groove part 112 is not limited thereto, and may be modified depending on a material, a degree of hardening, and the like, of the first body part 110.

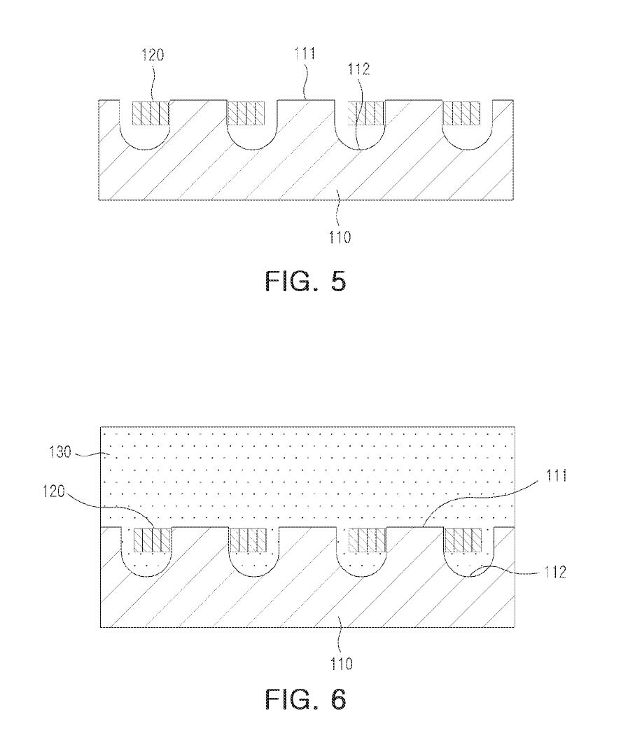

Referring to FIG. 5, a size of a top portion of the pillar part 111 may be less than a size of a bottom portion thereof. The top portion of the pillar part 111 is closer to the second body part 130 than the bottom portion. The top portion of the pillar part 111 may linearly extend towards the bottom portion thereof. The size of the bottom portion of the pillar part 111 may gradually increase in a direction away from the second body part 30. Thus, the central portion of the winding coil 120 may be fitted onto the pillar part 111 of the first body part 110, and the winding coil 120 may be stably seated in the body part, since when an inner size of the winding coil 120 is slightly greater than that of the top portion of the pillar part 111 but smaller than the bottom portion of the pillar part 111, each winding coil 120 may only directly contact one of the pillar parts 111 and will not be moveable in a horizontal direction perpendicular to the thickness direction. In a case in which a plurality of pillar parts 111 are formed in the first body part 110, a plurality of winding coils 120 may be fitted onto the plurality of pillar parts 111, respectively.

Here, the winding coil 120, which is a coil wound at least once or more, may be an air-core coil in which the pillar part 111 may be accommodated.

In a case in which the step is formed in the first body part 110 by dicing the first body part, such that the pillar part 111 and the groove part 112 are formed in the first body part 110, the central portion of the winding coil 120, which is an air-core part of the winding coil 120, may be fitted onto the pillar part 111, and the winding part of the winding coil 120 may be seated in the groove part 112, whereby the winding coil 120 may be stably seated in the body part.

Meanwhile, the winding coil 120 may be electrically connected to the external electrodes formed on the outer surfaces of the chip component. For example, both end portions of the winding coil 120 may be electrically connected to the external electrodes, respectively.

Referring to FIG. 6, the winding coil 120 may be embedded between the first body part 110 and the second body part 130 by adding the second body part 130 to the first body part 110 to cover the winding coil 120.

The second body part 130, which is provided in the chip component and forms the exterior of the chip component, together with the first body part 110, may be provided in the surrounding space of the winding coil 120. The second body part 130 may contain one or more of a magnetic metal powder, ferrite, a resin mixture, and the like, similar to the first body part 110. For example, the second body part 130 may be formed of a magnetic material-resin composite in which magnetic metal powder and a resin mixture are mixed with each other. Alternatively, the second body part 130 may be formed of a magnetic material-resin composite in which ferrite and a resin mixture are mixed with each other. Alternatively, the second body part 130 may be formed of only a resin mixture, but is not limited thereto.

In particular, in the embedding of the winding coil 120, the second body part 130 may be molded in the sheet type and compressed to the first body part 110. For example, in the second body part 130, the magnetic metal powder, the resin mixture, and the like, may be molded in the sheet type, and may be stacked, compressed, and then hardened on at least one surface of the first body part 110 the winding coil 120. The second body part 130 may be formed of the same material as that of the first body part 110 or formed of a material different from that of the first body part 110.

In the embedding of the winding coil 120, the winding coil 120 may be embedded between the first body part 110 and the second body part 130 by stacking the second body part 130 on the upper surface of the first body part 110. As an example, in a case in which the pillar part 111 is formed by processing the upper surface of the first body part 110 and the winding coil 120 is fixed onto the pillar part 111, the winding coil 120 may be embedded between the first body part 110 and the second body part 130 by forming the second body part 130 on the upper surface of the first body part 110.

As another example, in a case in which the pillar part 111 is formed by processing the lower surface of the first body part 110 and the winding coil 120 is fixed onto the pillar part 111, the winding coil 120 may be embedded between the first body part 110 and the second body part 130 by forming the second body part 130 on the lower surface of the first body part 110.

Then, the body part including the first body part 110 and the second body part 130 may be compressed and hardened.

Meanwhile, the first body part 110 may be hardened at strength greater than that of the second body part 130. Therefore, the first body part 110 may be diced, and thus the step may be formed in the first body part 110. In addition, the second body part 130 may be hardened at strength less than that of the first body part 110, and may cover an upper portion or a lower portion of the processed first body part 110 to embed the winding coil 120 between the first body part 110 and the second body part 120 and be provided in a space between the pillar part 111 and the groove part 112.

A schematic side view of the chip component completed by the method of manufacturing a chip component according to an exemplary embodiment in the present disclosure is illustrated in FIG. 7. Individual chips including at least one winding coil may be formed by compressing and hardening the first body part 110 and the second body part 130 to each other and then cutting the body part.

Here, the step between the pillar part 111 and the groove part 112 may be formed on the interface between the first body part 110 and the second body part 130.

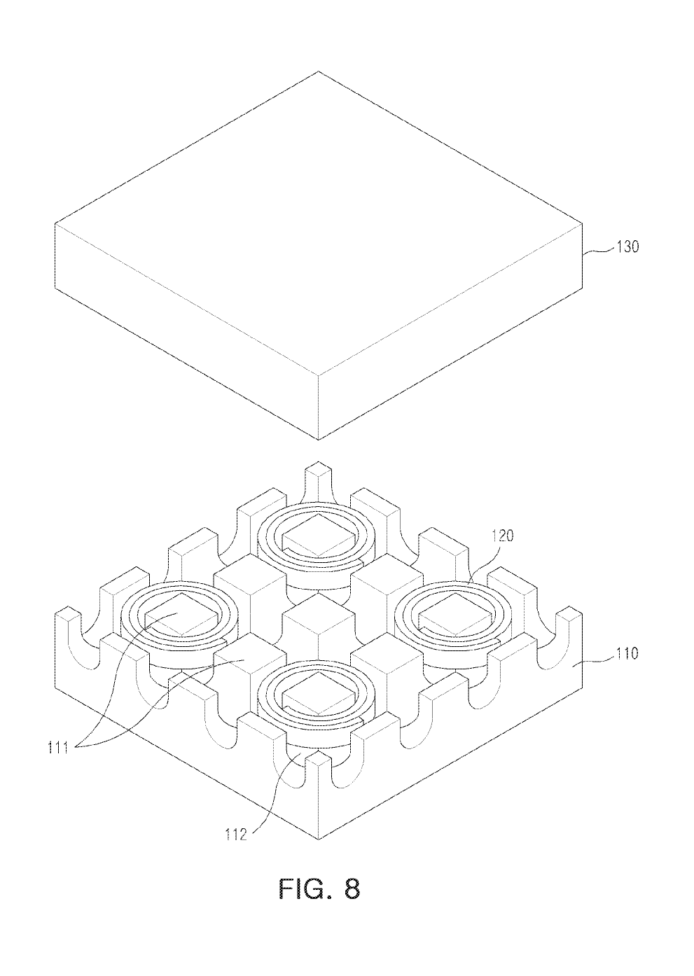

FIG. 8 is a view illustrating the method of manufacturing a chip component according to an exemplary embodiment in the present disclosure.

Referring to FIG. 8, the method of manufacturing a chip component will be described on the basis of the content described above.

For example, in the method of manufacturing a chip component, the first body part 110 may be molded in the sheet type and hardened to a predetermined strength, and thus the first body part may be in a state in which it may be diced. Then, the first body part 110 may be diced using the dicing blade, and thus the at least one pillar part 111 may be formed in the first body part 110. The central part of the winding coil 120 may be fitted onto the pillar part 111 formed as described above to stably seat the winding coil, and the second body part 130 may be added to embed the winding coil 120 between the first body part 110 and the second body part 130. Here, the second body part 130 may be molded in the sheet type, and may then be compressed and hardened to the first body part 110.

In a case in which the plurality of pillar parts 111 are formed in the first body part 110 and the plurality of winding coils 120 are seated onto the plurality of pillar parts 111, respectively, the individual chips including at least one winding coil 120 may be formed by cutting the body part.

As described above, the body part may be processed to form the pillar part 111, and the winding coils 120 may be fixed onto the pillar part 111, whereby the winding coil may be stably mounted. In addition, a method of fixing the winding coil may be improved through a change from a mold type process according to the related art into a sheet type process, whereby the winding coil may be stably fixed and a mass production system of the chip component may be secured.

As set forth above, according to an exemplary embodiment, the pillar part onto which the winding coil may be fixed may be formed in the body part to stably mount the winding coil, whereby a method of fixing the winding coil may be improved and the chip components may be mass-produced.

While exemplary embodiments have been shown and described above, it will be apparent to those skilled in the art that modifications and variations could be made without departing from the scope of the present invention as defined by the appended claims.

What is claimed is:

1. A chip component comprising:
a first body part in which at least one pillar part is formed;
a winding coil having a central portion fitted onto the at least one pillar part; and
a second body part stacked on the first body part so that the winding coil is embedded between the first body part and the second body part.

2. The chip component of claim 1, wherein inside the chip component, space surrounding the at least one pillar part but not occupied by the winding coil is completely filled with the second body part.

3. The chip component of claim 1, wherein the pillar part is formed on an upper surface of the first body part, and the second body part is stacked on the upper surface of the first body part.

4. The chip component of claim 1, wherein the first body part has a step between the pillar part onto which the central portion of the winding coil is fitted and a groove part in which the winding coil is seated.

5. The chip component of claim 1, wherein the first body part has strength greater than that of the second body part.

6. The chip component of claim 1, wherein a size of a top portion of the at least one pillar part is less than that of a bottom portion of the one pillar part, the top portion of the at least one pillar part being closer to the second body part than the bottom portion of the at least one pillar part.

7. The chip component of claim 6, wherein an inner size of the winding coil is greater than that of the top portion of the at least pillar part and less than that of the bottom portion of the at least pillar part.

8. The chip component of claim 6, wherein the size of the bottom portion of the at least one pillar part gradually increases in a direction away from the second body part.

9. The chip component of claim 6, wherein the top portion of the at least one pillar part linearly extends towards the bottom portion thereof.

10. The chip component of claim 1, further comprising a plurality of peripheral pillar parts surrounding the at least one pillar part.

11. The chip component of claim 10, wherein a first groove part between two adjacent pillar parts of the plurality of peripheral pillar parts on a first side surface of the first body part, a second groove part between two adjacent pillar parts of the plurality of peripheral pillar parts on a second side surface of the first body part opposing the first side surface thereof, and a third groove part between the at least one pillar part and one of the plurality of peripheral pillar parts on a third side surface of the first body part connecting the first and second side surfaces, are aligned to each other in a direction parallel the third side surface.

12. The chip component of claim 11, wherein the winding coil does not directly contact any of the plurality of peripheral pillar parts.

13. A method of manufacturing a chip component, comprising:
forming at least one pillar part by processing a first body part;
fitting and seating a central portion of a winding coil onto the at least one pillar part;
embedding the winding coil between the first body part and a second body part by adding the second body part; and
compressing and hardening a body part including the first body part and the second body part.

14. The method of claim 13, further comprising forming individual chips by cutting the body part.

15. The method of claim 13, wherein the embedding of the winding coil includes embedding the winding coil between the first body part and the second body part by stacking the second body part on an upper surface of the first body part.

16. The method of claim 13, wherein in the embedding of the winding coil, the second body part is molded in a sheet type and is compressed to the first body part such that the second body part completely fills space surrounding the at least one pillar part but not occupied by the winding coil.

17. The method of claim 13, wherein the forming of the at least one pillar part includes dicing the first body part to form the pillar part onto which the central portion of the winding coil is fitted and a groove part in which the winding coil is seated.

18. The method of claim 17, wherein the forming of the at least one pillar part further includes molding the first body part in a sheet type and hardening the first body part to a predetermined strength so as to be diced.

19. The method of claim 17, wherein the dicing the first body part to form the at least one pillar part partially cuts the first body part in a thickness direction thereof.

20. The method of claim 13, wherein the first body part has strength greater than that of the second body part.
